(19) United States
(12) Patent Application Publication
(10) Pub. No.: US 2026/0241707 A1
(43) Pub. Date: Aug. 20, 2026

(54) IMAGE FORMING APPARATUS, AND NON-TRANSITORY STORAGE MEDIUM STORING PROGRAM

(71) Applicant: Kyosuke Terada, Mishima Shizuoka (JP)

(72) Inventor: Kyosuke Terada, Mishima Shizuoka (JP)

(73) Assignee: ETRIA Co., Ltd., Kanagawa (JP)

(21) Appl. No.: 19/447,089

(22) Filed: Jan. 13, 2026

(30) Foreign Application Priority Data
Feb. 19, 2025 (JP) 2025-025278

(51) Int. Cl. B41J 2/36; B41J 2/325

(52) U.S. Cl. CPC B41J 2/36; B41J 2/325

(57) ABSTRACT

According to one embodiment, an image forming apparatus includes a convey unit, a thermal head, a head driving unit, and a processor. The convey unit conveys a medium. The thermal head includes a plurality of heating elements arranged in a print line perpendicular to a convey direction of the medium by the convey unit. The head driving unit heats the heating elements corresponding to dots for one line in accordance with image data for each of the print lines. The processor sets a convey speed of the medium, and sets, in accordance with the convey speed, a number of times of application by which the head driving unit heats each of the heating elements of the thermal head.

### CROSS REFERENCE TO RELATED APPLICATIONS

This application is based upon and claims the benefit of priority from Japanese Patent Application No. 2025-025278, filed February 19, 2025, the entire contents of which are incorporated herein by reference.

### FIELD

Embodiments of the present invention relate generally to an image forming apparatus, and a non-transitory storage medium storing a program.

### BACKGROUND

A thermal printer functioning as an image forming apparatus includes a thermal head functioning as a thermal head in which heating elements are arranged in a print line. In the thermal printer, an application time of each of dots in one line in a main scan direction is specified in accordance with a convey speed of a medium on which an image is formed. In the thermal printer, thermal control for the heating elements of the thermal head in the time of application for one dot is determined in accordance with a printing condition such as density setting.

In a conventional thermal printer, in many cases, the number of times of application for heating each heating element, as the thermal control for the thermal head, is fixed on a machine-by-machine basis. In such a thermal printer, since the number of times of application is fixed, the print density is controlled by adjusting the time of application for each heating element of the thermal head. However, in the thermal printer, there is a problem that it is difficult to execute control to print an image with a clear density, by only the time of application for the heating element.

### BRIEF DESCRIPTION OF THE DRAWINGS

FIG. 1 is a perspective view illustrating an example of an external appearance of a thermal printer functioning as an image forming apparatus according to an embodiment.

FIG. 2 is a schematic cross-sectional view illustrating an example of an internal configuration of the thermal printer functioning as the image forming apparatus according to the embodiment.

FIG. 3 is a block diagram illustrating a configuration example of a control system in the thermal printer functioning as the image forming apparatus according to the embodiment.

FIG. 4 is a flowchart for describing a flow of a print process including a setting process of the number of times of application in the thermal printer functioning as the image forming apparatus according to the embodiment.

FIG. 5 is a flowchart for describing the flow of the print process including the setting process of the number of times of application in the thermal printer functioning as the image forming apparatus according to the embodiment.

### DETAILED DESCRIPTION

According to one embodiment, an image forming apparatus includes a convey unit, a thermal head, a head driving unit, and a processor. The convey unit conveys a medium. The thermal head includes a plurality of heating elements arranged in a print line perpendicular to a convey direction of the medium by the convey unit. The head driving unit heats the heating elements corresponding to dots for one line in accordance with image data for each of the print lines. The processor sets a convey speed of the medium, and sets, in accordance with the convey speed, a number of times of application by which the head driving unit heats each of the heating elements of the thermal head.

Hereinafter, a thermal printer functioning as an image forming apparatus according to an embodiment is described with reference to the accompanying drawings.

FIG. 1 is a perspective view illustrating an example of an external appearance of a thermal printer 10 functioning as the image forming apparatus according to the embodiment.

In the configuration example illustrated in FIG. 1, the thermal printer 10 includes a left-side case 11, and a case 12 coupled to a right side of the case 11 by hinges 13. The front panel 14 of the case 11 includes a power switch 15, a display unit 16 and an operation unit 17. The display unit 16 is constituted by, for example, a liquid crystal display equipped with a backlight. However, as the display unit 16, a display device other than the liquid crystal display may be used. The operation unit 17 includes a plurality of operation buttons 18. For example, the display unit 16 and the operation unit 17 may be constituted by a display device equipped with a touch panel.

The right-side case 12 is configured to rotate around the hinges 13, thereby being capable of widely opening the inside of a housing (i.e., cases 11 and 12). The thermal printer 10 includes, in the inside of the housing, a medium (sheet) 27 that is wound in a roll shape, an ink ribbon 41 that is passed between two shafts, and a print unit 23 that performs printing on the ink ribbon. The thermal printer 10 is configured such that the replacement of the ink ribbon 41 or sheet 27, or the maintenance of the inside, can be performed by rotating the case 12 upward around the hinges 13. A front panel 19 of the case 12 is provided with an issue port 20. The thermal printer 10 issues, from the issue port 20, a medium (label) after a print process (image forming process).

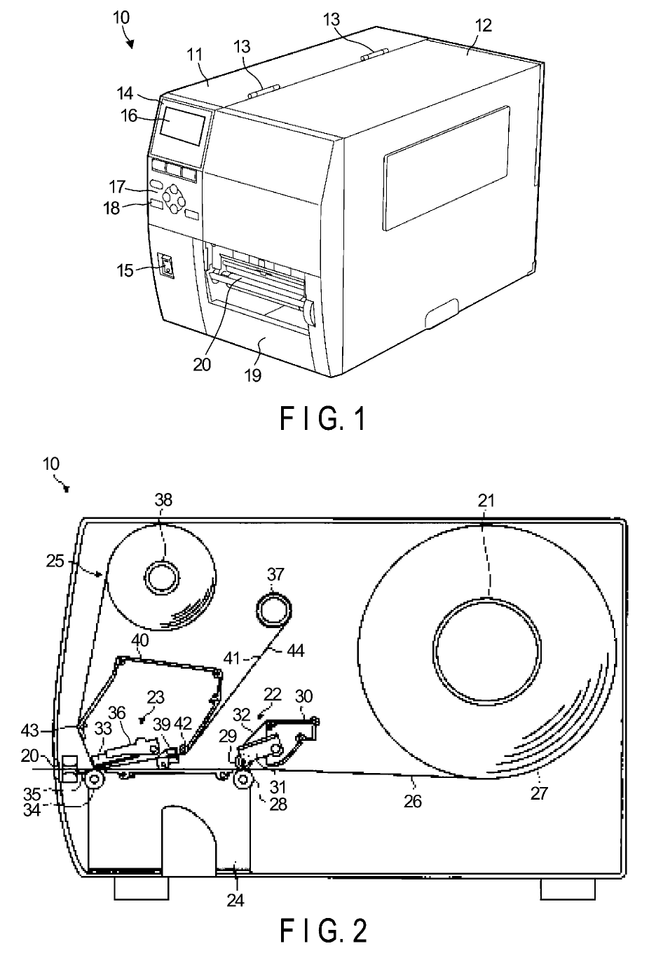

FIG. 2 is a schematic cross-sectional view illustrating an example of an internal configuration of the thermal printer 10. As illustrated in FIG. 2, the thermal printer 10 includes, in the inside of the housing, a sheet holder 21, a sheet convey unit (convey unit) 22, a print unit 23, a frame 24, and an ink ribbon feed device 25.

The sheet holder 21 is a shaft for winding the sheet 27 in a roll shape and supporting the sheet 27 in the roll shape. The sheet 27 is drawn out from the sheet holder 21, is passed through the sheet convey unit 22, is printed by the print unit 23, and is then output from the issue port 20. The sheet 27 may be, for example, a medium (label sheet) in which a label is attached on backing paper, or a medium that is cut with a predetermined length in the convey direction after the print process. The medium used as the sheet 27 is not limited to the medium on which ink is transferred, and may be thermosensitive paper.

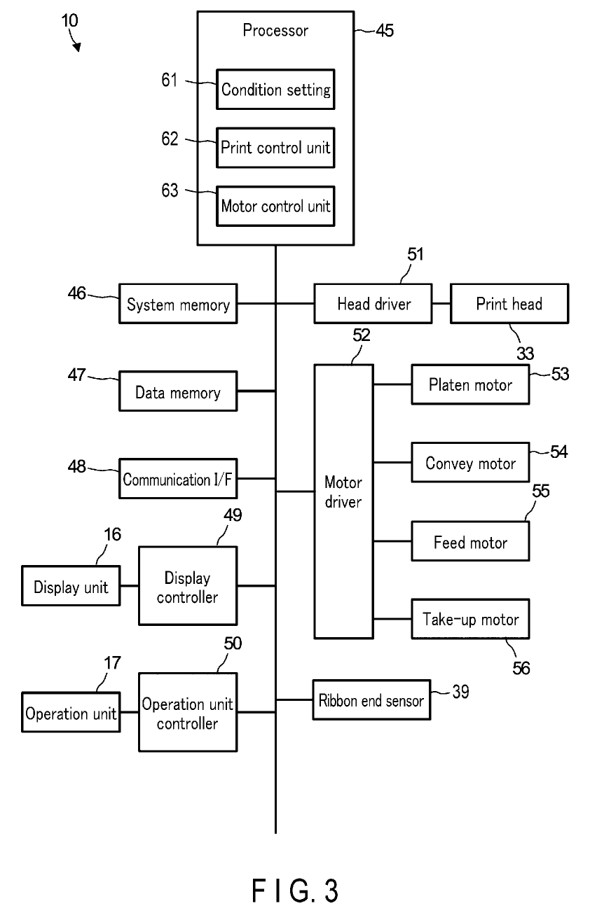

The sheet convey unit 22 includes a sheet convey roller 28, a pinch roller 29, a frame 30, a support portion 31, and a plate spring 32. The pinch roller 29 is rotatably supported on the support portion 31. The sheet convey roller 28 and the pinch roller 29 are put in contact via the sheet 27 that is conveyed along a convey path 26. The sheet convey roller 28 is rotatably attached to the frame 24, and is driven and rotated by a driving structure including a convey motor 54 (see FIG. 3) to be described later.

The support portion 31 is pivotably attached to the frame 30. In addition, one end of the plate spring 32 is attached to the frame 30, and the other end of the plate spring 32 is put in contact with the pinch roller 29. The pinch roller 29 is configured to be urged by the plate spring 32 and to be put in contact with the sheet convey roller 28.

The convey path 26 of the sheet 27 begins at a location at which the sheet 27 is drawn out from the sheet holder 21. The convey path 26 passes through a position at which the pinch roller 29 and the sheet convey roller 28 are put in contact in the sheet convey unit 22. Further, the convey path 26 passes through a position at which the thermal head (print head) 33 of the print unit 23 and the platen 34 are put in contact, and ends at the issue port 20.

In addition, in the configuration example illustrated in FIG. 2, it is assumed that a label peel plate 35 is provided on a downstream side in the convey direction of the print unit 23 along the convey path 26. In a case where the sheet 27 is a label sheet, the label peel plate 35 bends the sheet 27 that is being conveyed, and peels the label and the backing paper from each other. The peeled backing paper is taken up by a take-up shaft (not illustrated), and the label peeled from the backing paper is issued from the issue port 20.

The print unit 23 includes the thermal head 33 and the platen 34. The thermal head 33 is a line-type thermal printer head. The thermal head 33 is configured such that a plurality of heating elements for one line (print line) are arranged in a main scan direction that is a perpendicular direction to the convey direction of the sheet 27. Each heating element in the thermal head 33 prints each dot of an image that is formed on the sheet 27. Each heating element of the thermal head 33 includes a resistor or the like, and is connected to a driving circuit (driver). A predetermined voltage is applied (conducted) to each heating element of the thermal head 33 by the driving circuit, and thereby each heating element produces heat.

With respect to each heating element of the thermal head 33, the time (application time, conduction time) in which the voltage is applied (conducted) for printing one dot and the number of times (number of times of application, number of times of conduction) are controlled in accordance with a printing condition. The heating state of each heating element of the thermal head 33 is controlled by the time of application and the number of times of application being controlled. In addition, in the thermal printer 10 according to the embodiment, a period (print period) in which each heating element of the thermal head 33 prints one line (one dot) is set. Thus, with respect to each heating element of the thermal head 33, the number of times of application in the print period for printing one dot is set in accordance with the printing condition such as density setting.

The platen 34 is rotatably attached to the frame 24, and is rotated and driven by a driving unit (not illustrated). The platen 34 rotates and thereby conveys the sheet 27 on which an image is printed. The thermal head 33 is provided to be opposed to the platen 34. The thermal head 33 applies a print process to the sheet 27 that is conveyed between the thermal head 33 and the platen 34. The thermal head 33 is fixed to a head holder 36 that is rotatably attached to a frame (not illustrated).

The ink ribbon feed device 25 includes a ribbon hold shaft 37, a ribbon take-up shaft 38, a ribbon end sensor 39, and a guide frame 40. The ink ribbon 41 that is unused is wound around the ribbon hold shaft 37 in a roll shape. A guide roller 42, which guides the ink ribbon 41 drawn out from the ribbon hold shaft 37, is provided at an end portion on the ribbon hold shaft 37 side of the guide frame 40. The guide roller 42 is rotatably provided on the guide frame 40.

The ink ribbon 41 before printing is put in contact with the guide roller 42, and then the ink ribbon 41 passes through the detection target area of the ribbon end sensor 39. Then, the ink ribbon 41 reaches a position where the thermal head 33 and the platen 34 are in contact with each other, and transfer is performed by the thermal head 33. After coming in contact with an end portion 43 on the ribbon take-up shaft 38 side of the guide frame 40, the ink ribbon 41 after printing is taken up by the ribbon take-up shaft 38 and is recovered.

Specifically, the convey path 44 of the ink ribbon 41 begins at a location at which the ink ribbon 41 is drawn out from the ribbon hold shaft 37, and passes through the position of contact with the guide roller 42 of the guide frame 40. The convey path 44 successively passes through the detection target area of the ribbon end sensor 39 and the position (i.e., print position) at which the thermal head 33 and the platen 34 are in contact with each other. Further, the convey path 44 passes through the position of contact with the end portion 43 of the guide frame 40, and ends at a location of the take-up by the ribbon take-up shaft 38.

The ribbon end sensor 39 is a sensor that detects a ribbon end, that is, a terminal end of the ink ribbon 41. As illustrated in FIG. 2, the ribbon end sensor 39 is disposed on the convey path 44 between the print unit 23 and the ribbon hold shaft 37. The ribbon end sensor 39 is provided, for example, along the convey path 44 of the ink ribbon 41, and is provided between the print unit 23 and the guide roller 42 on the convey path 44. In addition, the ribbon end sensor 39 may be provided between the position (i.e., the print position, or the transfer position) at which the thermal head 33 and the platen 34 are put in contact in the print unit 23, and the guide roller 42.

In a case where the guide frame 40 is a frame of a type that does not include the guide roller 42, the position of disposition of the ribbon end sensor 39 is between the position at which the thermal head 33 and the platen 34 are put in contact, and the end portion on the ribbon hold shaft 37 side of the guide frame 40.

As the ribbon end sensor 39, use may be made of an optical sensor that optically detects the ink ribbon 41. In a preferable example, as the ribbon end sensor 39, use may be made of a reflection light sensor including a light emission element and a light reception element. Note that, as the ribbon end sensor 39, a sensor that mechanically detects the ink ribbon 41 may be used.

Next, a description is given of a hardware configuration of a control system in the thermal printer 10 functioning as the image forming apparatus according to the embodiment.

FIG. 3 is a block diagram illustrating the hardware configuration of the control system in the thermal printer 10 functioning as the image forming apparatus according to the embodiment.

As illustrated in FIG. 3, the thermal printer 10 includes, as structures of the control system, a processor 45, a system memory 46, a data memory 47, a communication interface (I/F) 48, a display controller 49, an operation unit controller 50, a head driver (head driving unit) 51, and a motor driver 52.

For example, electronic circuits or the like, which function as the processor 45, system memory 46, data memory 47, communication interface 48, display controller 49, operation unit controller 50, head driver 51 and motor driver 52, are disposed on a circuit board that is housed in the case 11 of the thermal printer 10. In addition, the motors 53 to 56 are also housed in the case 11 of the thermal printer 10.

The processor 45 executes control of the thermal printer 10. The processor 45 is connected, via a bus or an interface, to the system memory 46, data memory 47, communication interface 48, display controller 49, operation unit controller 50, head driver 51, motor driver 52 and ribbon end sensor 39. The processor 45 is, for example, a CPU (Central Processing Unit). The processor 45 executes various processes to be described later, by executing programs.

Note that the processor 45 may include hardware circuitry, such as an ASIC (Application Specific Integrated Circuit), a DSP (Digital Signal Processor), an FPGA (Field-Programmable Gate Array), and a GPU (Graphics Processing Unit). In this case, some or all of various functions to be described later may be executed by the hardware circuitry included in the processor 45.

The system memory 46 includes memories such as a ROM (Read Only Memory) and a RAM (Random Access Memory). The ROM included in the system memory 46 is a nonvolatile memory, and stores a program that the processor 45 executes, and various data for executing the program. For example, as the ROM 46 of the system memory 46, the ROM stores various programs and setting data in accordance with the specifications of the thermal printer 10. In addition, the RAM included in the system memory 46 functions as a working memory that temporarily stores data of various programs and data in working, in a case where the processor 45 executes the programs.

The data memory 47 is constituted by a storage device including a nonvolatile memory that is capable of rewriting data. The data memory 47 stores programs that the processor 45 executes, setting information, control information, and display information. In addition, the data memory 47 may store print data or the like.

The communication interface 48 is an interface for communication with an external device. The communication interface 48 connects the thermal printer 10 and a host computer, and controls data communication between the thermal printer 10 and the host computer. Note that the host computer is, for example, an information processing apparatus including a communication function corresponding to the communication interface 48, and is an example of an apparatus that transmits print data (or a print command) to the thermal printer 10. Note that the print data may be input via the operation unit 17.

The display unit 16 (see FIG. 1) is connected to the display controller 49. Based on display data from the processor 45, the display controller 49 causes the display unit 16 to display a table screen such as an operation guidance.

The operation unit 17 (see FIG. 1) is connected to the operation unit controller 50. The operation unit controller 50 supplies to the processor 45 an input signal indicating an operation instruction that is input to the operation unit 17.

The thermal head 33 (see FIG. 2) is connected to the head driver 51. The thermal head 33 is a thermal head in which a plurality of heating elements corresponding to the respective print dots are provided in a line shape in a direction perpendicular to the convey direction of the sheet 27. The head driver 51 controls the heating state of each heating element by switching ON/OFF of power conduction (application) to each heating element in the thermal head 33. Specifically, the head driver 51 prints an image (print image) on the sheet 27 by controlling the heating state of each heating element in the thermal head 33. In the thermal printer 10 according to the embodiment, the head driver 51 controls the density of each dot printed on the sheet 27, by controlling the number of time of application, or the like, to each heating element of the thermal head 33 in accordance with a control signal from the processor 45.

A platen motor 53, a convey motor 54, a feed motor 55 and a take-up motor 56 are connected to the motor driver 52. The motor driver 52 controls the rotations of the motors 53 to 56. The motor driver 52 may be provided for each of the individual motors 53 to 56. The motor driver 52 controls the rotations of the motors 53 to 56 in accordance with instructions from the processor 45.

The motors 53 to 56 are constituted by, for example, stepping motors. However, the structures of the motors 53 to 56 are not limited to the structures of stepping motors, and may be any structures if the rotations of the motors 53 to 56 can be controlled by the motor driver 52.

The platen motor 53 is a motor that rotates and drives the platen 34 in the print unit 23. The convey motor 54 is a motor that rotates and drives the sheet convey roller 28 of the sheet convey unit 22. The rotations of the platen motor 53 and the convey motor 54 are controlled in accordance with the convey speed of the sheet 27. Specifically, the motor driver 52 rotates the platen motor 53 and the convey motor 54 at rotation speeds corresponding to the convey speed that the processor 45 designates. Thereby, the processor 45 controls the convey speed (print speed) of the sheet 27.

The feed motor 55 is a motor that rotates and drives the ribbon hold shaft 37. In the configuration example illustrated in FIG. 2, the feed motor 55 is disposed such that the rotational axis thereof is coaxial with the rotational axis of the ribbon hold shaft 37. The take-up motor 56 is a motor that rotates and drives the ribbon take-up shaft 38. In the configuration example illustrated in FIG. 2, the take-up motor 56 is disposed such that the rotational axis thereof is coaxial with the rotational axis of the ribbon take-up shaft 38.

In addition, the processor 45 operates as various processing units by executing programs. The programs that the processor 45 executes are stored (installed) in a non-transitory nonvolatile memory such as the ROM of the system memory 46 or the data memory 47.

For example, the programs installed in the thermal printer 10 may be provided by being recorded in computer-readable recording media, such as a CD-ROM, a flexible disc (FD), a CD-R, and a DVD (Digital Versatile Disk), as files of installable formats or executable formats.

Besides, the programs installed in the thermal printer 10 may be stored in a computer connected to a network such as the internet, and may be downloaded in the thermal printer 10 via the network. In addition, the programs installed in the thermal printer 10 may be provided or distributed via a network such as the internet.

The processor 45 reads out a program from the memory such as the ROM of the system memory 46 or the data memory 47, and loads the program in the RAM (working memory) of the system memory 46. The processor 45 executes the program loaded in the RAM of the system memory 46, thereby operating as a processing unit that executes a process provided by the program.

FIG. 3 illustrates a condition setting unit 61, a print control unit 62 and a motor control unit 63, as examples of processing units that are implemented by the processor 45 executing programs. The processor 45 operates as the condition setting unit 61 by executing a program for condition setting. In addition, the processor 45 operates as the print control unit 62 by executing a program for print control. The processor 45 operates as the motor control unit 63 by executing a program for motor control.

The condition setting unit 61 sets a printing condition for executing a print process. The printing condition that the condition setting unit 61 sets includes setting values of an operation mode, a density setting and a print speed (convey speed). In addition, the condition setting unit 61 may set a kind of sheet as a printing condition.

For example, the thermal printer 10 according to the embodiment includes, as operation modes, a print mode of transferring an ink ribbon onto the sheet 27 (ribbon transfer mode), and a print mode of printing the sheet 27 as thermosensitive paper (thermosensitive paper print mode). In this case, the condition setting unit 61 sets either the ribbon transfer mode or the thermosensitive paper print mode as the operation mode. Note that in the thermal printer 10, the operation mode is switched by a switching work by the operator. Besides, in the thermal printer 10, the operation mode may be switched by an instruction from an external device.

The density setting of the printing condition that the condition setting unit 61 sets includes setting information of density in an image that is printed on the sheet 27. The density setting included in the printing condition can be designated by the operator. For example, the operator designates a desired density level from among a plurality of density levels. In addition, the operator may designate an addition or subtraction value of the density in relation to a predetermined standard density. In this case, the condition setting unit 61 may set, as the density setting, a standard density, an addition value for setting the density to be higher than the standard density, or a subtraction value for setting the density to be lower than the standard density.

Additionally, the print speed of the printing condition that the condition setting unit 61 sets corresponds to the convey speed of the sheet 27 during the print process. The print speed included in the printing condition can also be designated by the operator. In the print process, the thermal printer 10 conveys the sheet 27 at the convey speed corresponding to the print speed designated as the printing condition by the condition setting unit 61.

The print control unit 62 controls the printing on the sheet 27 by controlling the operation of the thermal head 33 by the head driver 51. The print control unit 62 executes thermal control of each heating element in the thermal head 33 in accordance with various printing conditions that are set by the condition setting unit 61. For example, the print control unit 62 controls the heating of each heating element corresponding to each dot to be printed, in accordance with the operation mode, the density setting and the print speed (convey speed), which are designated by the printing conditions.

The print control unit 62 specifies a period (print period) for printing one dot, and controls the time (time of application) and the number of times (number of times of application) for heating each heating element in the print period of one dot. For example, the print control unit 62 specifies the print period for one dot in accordance with the convey speed of the sheet, which is the print speed. The print control unit 62 divides the print period for printing one dot into a plurality of periods, and sets the number of times of application by setting the division number as the upper limit.

The motor control unit 69 controls the rotation and driving of the platen motor 53, convey motor 54, feed motor 55 and take-up motor 56 by the motor driver 52. For example, the motor control unit 69 causes the motor driver 52 to rotate and drive the motors 53 to 56 in accordance with the print speed, thereby controlling the convey speed of the sheet 27.

Next, a description is given of a flow of a print process including a setting process of the number of times of application in the thermal printer 10 functioning as the image forming apparatus according to the embodiment.

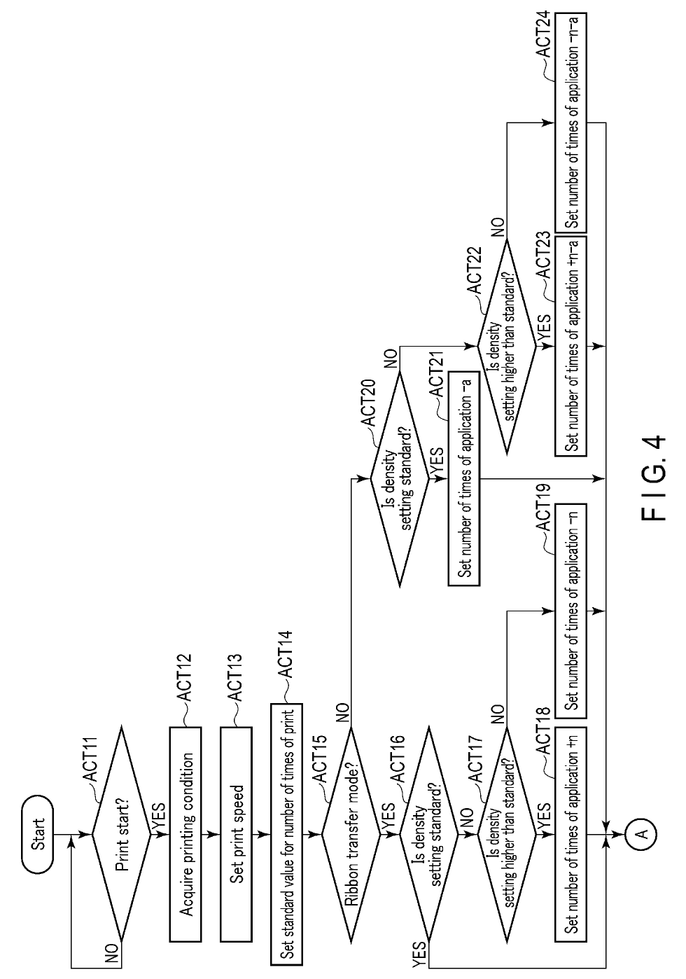

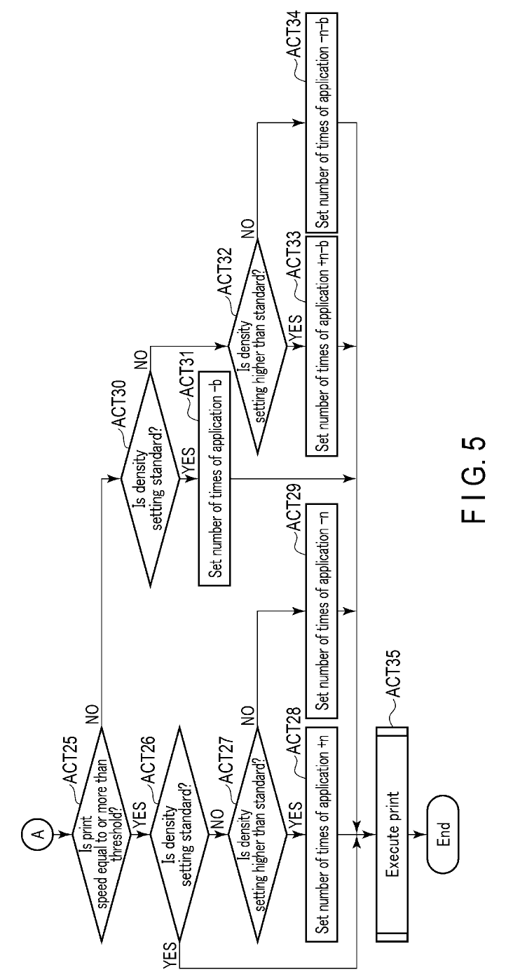

FIG. 4 and FIG. 5 are flowcharts for describing the flow of the print process including the setting process of the number of times of application in the thermal printer 10 functioning as the image forming apparatus according to the embodiment. In the standby state, the processor 45 of the thermal printer 10 accepts an instruction for a print start (ACT11). For example, the processor 45 accepts a command corresponding to an instruction input to the operation unit 17, or a command from an external device connected via the communication interface 48. Upon receiving the command (print command) instructing the print start, the processor 45 determines that the print process is to be started.

In the case of starting the print (ACT11, YES), the processor 45 acquires a printing condition that is applied to the print process to be executed (ACT12). For example, the processor 45 acquires information indicating the printing condition included in the print command that requests the print. In addition, the printing condition includes information including an operation mode (a ribbon transfer mode or a thermosensitive paper print mode), a density setting, a print speed, or a sheet setting of a sheet used in printing. Here, it is assumed that an operator who requests print can designate the density setting and the print speed included in the printing condition.

For example, as regards the designation of the density setting, the operator may designate an addition or subtraction value for a print density that is a standard setting (a standard value of print density). In a concrete example, it is assumed that the thermal printer 10 can set the print density stepwise. In this case, the operator designates a step number (density of standard value + n step(s)) for making the density higher than a standard density, or designates a step number (density of standard value - n step(s)) for making the density lower than the standard density. Based on the density setting included in the printing condition, the processor 45 may specify a change value (an addition value for increasing the density, or a subtraction value for decreasing the density) with reference to the standard density (a standard value or a standard density range).

Additionally, as regards the designation of the print speed, the operator may designate an addition or subtraction value for a print speed that is a standard setting (a standard print speed). In this case, based on the print speed included in the printing condition, the processor 45 may specify a change value (an addition value for making the print speed higher than the standard print speed, or a subtraction value for making the print speed lower than the standard print speed) with reference to the standard print speed.

Additionally, in the thermal printer 10 in which the operation mode is determined (set) by a setting work by the operator, the processor 45 may determine the currently set operation mode to be the printing condition. Besides, the processor 45 may determine whether the operation mode designated by the print command coincides with the operation mode that is currently set in the thermal printer 10. In this case, if the operation mode designated by the print command does not coincide with the currently set operation mode, the processor 45 may prompt switching of the operation mode of the thermal printer 10 to the operation mode designated by the print command.

Upon acquiring the printing condition, the processor 45 sets the print speed, based on the information indicating the print speed included in the printing condition (ACT13). In the thermal printer 10 according to the configuration example illustrated in FIG. 1 and FIG. 2, the thermal head 33, which is disposed at a predetermined position in relation to the conveyed sheet 27, performs printing on the sheet 27 that is conveyed at the predetermined position. Thus, the print speed corresponds to the speed (convey speed) of conveyance of the sheet 27 in the print process. Specifically, the processor 45 sets the convey speed of the sheet 27 in accordance with the print speed included in the printing condition.

The processor 45 executes the setting process of the number of times of application for setting the number of times of application as the thermal control for each heating element of the thermal head 33 corresponding to each dot. In order to set the number of times of application, the processor 45, to begin with, sets a predetermined standard value (a standard number of times of application) as the number of times of application (ACT14). It is assumed, however, that the standard value of the number of times of application in the thermal printer 10 is prestored in the ROM of the system memory 46 or the data memory 47.

Upon setting the standard value for the number of times of application, the processor 45 determines whether the operation mode set in the printing condition is the ribbon transfer mode or the thermosensitive paper print mode (ACT15). Specifically, the processor 45 determines whether the print process that is to be executed according to the printing condition is the ribbon transfer mode in which the ink ribbon is transferred onto the sheet 27, or the thermosensitive paper print mode in which printing is performed on thermosensitive paper without using the ink ribbon.

If the print process that is to be executed according to the printing condition is the ribbon transfer mode (ACT15, YES), the processor 45 advances to ACT16 in order to set the number of times of application as the thermal control in the print process in the ribbon transfer mode in which the ink ribbon is transferred onto the sheet. On the other hand, if the print process that is to be executed according to the printing condition is the thermosensitive paper print mode (ACT15, NO), the processor 45 advances to ACT20 in order to set the number of times of application as the thermal control in the print process in the thermosensitive paper print mode in which printing is performed on the thermosensitive paper.

If the print process that is to be executed is the ribbon transfer mode, the processor 45 determines whether or not the density setting designated by the printing condition is the standard density (ACT16). Here, the standard density is set in advance, and stored in the system memory 46 or the data memory 47. Besides, the standard density may be a predetermined density value, or a predetermined density range. If the density setting is the standard density (ACT16, YES), the processor 45 keeps the number of times of application as the standard value, and advances to ACT25.

If the density setting is not the standard density in the ribbon transfer mode (ACT16, NO), the processor 45 determines whether the density designated by the density setting is higher than the standard density (standard density +n) (ACT17). Here, the processor 45 specifies an addition or subtraction value (addition value or subtraction value) for the standard density, as the density designated by the density setting. For example, if the density setting is higher than the standard density, the processor 45 specifies an addition value (+n) for the standard density, and if the density setting is lower than the standard density, the processor 45 specifies a subtraction value (-n) for the standard density.

If the density setting in the ribbon transfer mode is higher than the standard density (ACT17, YES), the processor 45 updates the number of times of application in accordance with the addition value for the standard density (ACT18). For example, if the addition value for the standard density is +n, the processor 45 updates the number of times of application to a value obtained by adding n to the number of times of application (the addition number of times corresponding to the addition value n). However, in ACT18, it is assumed that the number of times of application is updated, with the upper limit being set to be the upper limit value of the number of times of application that can be set during the print period for printing one line (one dot) in the main scan direction. If the number of times of application corresponding to the addition value for the standard density exceeds the upper limit value of the settable number of times of application, the processor 45 may set the number of times of application at the upper limit value.

If the density setting in the ribbon transfer mode is lower than the standard density (ACT17, NO), the processor 45 updates the number of times of application in accordance with the subtraction value for the standard density (ACT19). For example, if the subtraction value for the standard density is -n, the processor 45 updates the number of times of application to a value obtained by subtracting n from the number of times of application. However, in ACT19, it is assumed that the number of times of application is updated, such that the number of times of application that can be set during the print period for printing one line (one dot) in the main scan direction does not become less than one (lower limit value). In the case where the number of times of application corresponding to the subtraction value for the standard density of the density setting becomes less than one, the processor 45 may set the number of times of application at one (lower limit value).

In FIG. 4, it is assumed that the addition number of times n is added to the number of times of application (or the subtraction number of times -n is subtracted from the number of times of application) in accordance with the addition value n (or the subtraction value -n) for the standard density of the density setting in the ribbon transfer mode, but the embodiment is not limited to this. Specifically, the update number of times of the number of times of application for the addition or subtraction value for the standard density (the addition number of times or the subtraction number of times) may be set in accordance with the print characteristics in the ribbon transfer mode, and a linear relationship may not be established between the addition or subtraction value for the standard density of the density setting and the update number of times of the number of times of application.

If the print process to be executed is the thermosensitive paper print mode, the processor 45 determines whether or not the density setting designated by the printing condition is the standard density (standard setting) (ACT20). If the density setting in the thermosensitive paper print mode is the standard density (ACT20, YES), the processor 45 subtracts a predetermined number of times a from the number of times of application (ACT21). For example, if the density setting in the thermosensitive paper print mode is the standard density, the processor 45 updates the number of times of application to -1 (standard number of times -1). Here, the predetermined number of times a is a set value that is set in advance in accordance with the print speed and is stored in the system memory 46 or the data memory 47.

In the ribbon transfer mode, since the ribbon ink needs to be melted by heat and transferred onto the sheet, it is considered necessary to apply a greater quantity of thermal energy to the heating elements of the thermal head 33 than in the thermosensitive paper print mode. Thus, in order to achieve printing with the same degree of density regardless of the operation mode, it is necessary to make smaller the number of times of application to the heating elements in the thermosensitive paper print mode than in the ribbon transfer mode. Accordingly, although the number of times of application is unchanged in the ribbon transfer mode if the density setting is the standard density, the predetermined number of times a is subtracted from the number of times of application in the thermosensitive paper print mode even if the density setting is the standard density.

Here, the predetermined number of times a is set in accordance with the difference in density occurring between the ribbon transfer mode and the thermosensitive paper print mode. Specifically, the predetermined number of times a is set as a difference number of times of the number of times of application for achieving the same degree of print density between different operation modes. Thereby, in the thermosensitive paper print mode, by decreasing the predetermined number of times a from the number of times of application, the print density can be adjusted to become substantially the same degree as in the print process in the ribbon transfer mode.

In addition, if the density setting in the thermosensitive paper print mode is not the standard density (ACT20, NO), the processor 45 determines whether the density setting is higher than the standard density (ACT22). Here, the processor 45 specifies an addition or subtraction value (addition value or subtraction value) for the standard density with respect to the density designated by the density setting. For example, the processor 45 determines whether the density setting in the printing condition is an addition of the addition value n to the standard density (standard density +n), or a subtraction of the subtraction value n from the standard density (standard density -n).

If the density indicated by the density setting in the thermosensitive paper print mode is higher than the standard density (ACT22, YES), the processor 45 updates the number of times of application in accordance with the addition value for the standard density (ACT23). For example, if the addition value for the standard density is n, the processor 45 updates the number of times of application to a value (standard density +n-a) that is obtained by adding a value, which is obtained by subtracting the predetermined number of times a from the addition value n, to the number of times of application. However, in ACT23, it is assumed that the number of times of application is updated, with the upper limit being set to be the upper limit value of the number of times of application that can be set during the print period for printing one line (one dot) in the main scan direction. If the number of times of application corresponding to the addition value for the standard density exceeds the upper limit value of the settable number of times of application, the processor 45 may set the number of times of application at the upper limit value.

If the density setting in the thermosensitive paper print mode is lower than the standard density (ACT22, NO), the processor 45 updates the number of times of application in accordance with the subtraction value for the standard density (ACT24). For example, if the subtraction value for the standard density is -n, the processor 45 updates the number of times of application to a value (here, standard density -n-a) obtained by subtracting -n from the number of times of application and further subtracting the predetermined number of times a from the number of times of application. However, in ACT24, it is assumed that the number of times of application is updated, such that the number of times of application that can be set during the print period for printing one line (one dot) in the main scan direction does not become less than one (lower limit value). For example, in the case where the number of times of application corresponding to the subtraction value for the standard density of the density setting becomes less than one, the processor 45 may set the number of times of application at one (lower limit value).

In FIG. 4, it is assumed that n-a is added to the number of times of application (or -n-a is subtracted from the number of times of application) in accordance with the addition value n (or subtraction value -n) for the standard value of the density setting in the thermosensitive paper print mode, but the embodiment is not limited to this. Specifically, the update number of times (the addition number of times or the subtraction number of times) of the number of times of application corresponding to the addition or subtraction value for the standard density may be set in accordance with print characteristics in the photosensitive paper print mode, and the addition or subtraction value for the standard density of the density setting may not have a linear relation to the update number of times of the number of times of application.

In the above-described operation example, it is assumed that the thermal printer 10 has a single standard number of times of the number of times of print, regardless of the operation mode, but standard numbers of times for the number of times of print may be set for the respective operation modes. For example, the thermal printer 10 may set the standard number of times of the number of times of print in the ribbon transfer mode and the standard number of times of the number of times of print in the thermosensitive paper print mode, respectively. In this case, the thermal printer 10 may execute the process of ACT16 to ACT19 for the standard number of times of the number of times of print in the ribbon transfer mode, and may execute the process of ACT20 to ACT24 for the standard number of times of the number of times of print in the thermosensitive paper print mode.

Next, if the processor 45 sets the number of times of application corresponding to the operation mode in ACT11 to ACT24, the processor 45 sets the number of times of application corresponding to the print speed. In ACT25, the processor 45 determines whether the print speed that is set according to the printing condition is equal to or more than a predetermined threshold (ACT25). Here, the predetermined threshold (speed threshold) is set by assuming a print speed at which a change may occur in the print density in the print result. Specifically, it is assumed that if the number of times of application is the same, a print result at a print speed that is equal to or more than the speed threshold becomes thinner than a print result at a print speed that is less than the speed threshold.

If the print speed is equal to or more than the predetermined threshold (ACT25, YES), the processor 45 further determines whether the density setting designated by the printing condition is the standard density (ACT26). If the density designated by the density setting is the standard density (ACT26, YES), the processor 45 keeps the number of times of application as the standard value, and advances to ACT35 and executes the print process.

If the print speed is equal to or more than the speed threshold and the density setting is not the standard density (ACT26, NO), the processor 45 determines whether the density indicated by the density setting is higher than the standard density (ACT27). Here, the processor 45 specifies an addition or subtraction value (n) for the standard density with respect to the density indicated by the density setting. For example, the processor 45 determines whether the density setting is an addition of an addition value n to the standard density (standard density +n), or a subtraction of a subtraction value -n from the standard density (standard density -n).

If the print speed is equal to or more than the speed threshold and the density setting is higher than the standard density (ACT27, YES), the processor 45 updates the number of times of application in accordance with the addition value for the standard density (ACT28). For example, if the addition value for the standard density is +n, the processor 45 updates the number of times of application to a value obtained by adding n to the number of times of application. However, in ACT28, it is assumed that the number of times of application is updated, with the upper limit being set to be the upper limit value of the number of times of application that can be set during the print period for printing one line (one dot) in the main scan direction. If the number of times of application corresponding to the addition value for the standard density exceeds the upper limit value of the settable number of times of application, the processor 45 may set the number of times of application at the upper limit value.

If the print speed is equal to or more than the speed threshold and the density setting is lower than the standard density (ACT27, NO), the processor 45 updates the number of times of application in accordance with the subtraction value for the standard density (ACT29). For example, if the subtraction value for the standard density is -n, the processor 45 updates the number of times of application to a value obtained by subtracting n from the number of times of application. However, in ACT29, it is assumed that the number of times of application is updated, such that the number of times of application that can be set during the print period for printing one line (one dot) in the main scan direction does not become less than one (lower limit value). In the case where the number of times of application corresponding to the subtraction value for the standard density of the density setting becomes less than one, the processor 45 may set the number of times of application at one (lower limit value).

In FIG. 5, it is assumed that in the case where the print speed is equal to or more than the speed threshold, the addition number n is added to the number of times of application (or the subtraction number -n is subtracted from the number of times of application) in accordance with the addition value n (or the subtraction value -n) for the standard density of the density setting, but the embodiment is not limited to this. Specifically, the update number of times of the number of times of application for the addition or subtraction value for the standard density (the addition number of times or the subtraction number of times) may be set in accordance with the print characteristics in the case where the print speed is equal to or more than the speed threshold, and a linear relationship may not be established between the addition or subtraction value for the standard density of the density setting and the update number of times of the number of times of application.

Also in the case where the print speed is less than the speed threshold, the processor 45 determines whether or not the density setting designated by the printing condition is the standard density (ACT30).

If the print speed is less than the speed threshold and the density setting is the standard density (ACT30, YES), the processor 45 subtracts a predetermined number of times b from the number of times of application (ACT31). For example, if the print speed is less than the speed threshold and the density setting is the standard density, the processor 45 updates the number of times of application to the number of times of application -b. Here, the predetermined number of times b is a set value that is set in advance in accordance with the print speed and is stored in the system memory 46 or the data memory 47.

In the case where the print speed is equal to or more than the speed threshold, in order to perform printing with the same degree of density, it is considered necessary to apply a greater quantity of thermal energy to the heating elements of the thermal head 33 than in the case where the print speed is less than the speed threshold. Thus, in order to achieve printing with the same degree of density regardless of the print speed, it is necessary to make smaller the number of times of application to the heating elements in the case where the print speed is less than the speed threshold than in the case where the print speed is equal to or more than the speed threshold. Accordingly, although the number of times of application is unchanged in the case where the print speed is equal to or more than the speed threshold if the density setting is the standard density, the predetermined number of times b is subtracted from the number of times of application in the case where the print speed is less than the speed threshold even if the density setting is the standard density.

Here, the predetermined number of times b is set in accordance with the difference in density occurring between the case where the print speed is equal to or more than the speed threshold and the case where the print speed is less than the speed threshold. Specifically, the predetermined number of times b is set as a difference number of times of the number of times of application (a difference number of times corresponding to a speed difference of the print speed) for achieving the same degree of print density between different print speeds. Thereby, in the case where the print speed is less than the speed threshold, by decreasing the predetermined number of times b from the number of times of application, the print density can be adjusted to become substantially the same degree as in the print process in the case where the print speed is equal to or more than the speed threshold.

In addition, if the print speed is less than the speed threshold and the density setting is not the standard density (ACT30, NO), the processor 45 determines whether the density setting is higher than the standard density (ACT32). Here, the processor 45 specifies an addition or subtraction value (addition value or subtraction value) for the standard density with respect to the density designated by the density setting. For example, the processor 45 determines whether the density setting in the printing condition is an addition of the addition value n to the standard density (standard density +n), or a subtraction of the subtraction value n from the standard density (standard density -n).

If the print speed is less than the speed threshold and the density setting is higher than the standard density (ACT32, YES), the processor 45 updates the number of times of application in accordance with the addition value for the standard density (ACT33). For example, if the addition value for the standard density is n, the processor 45 updates the number of times of application to a value (standard density +n-b) that is obtained by adding a value, which is obtained by subtracting the predetermined number of times b from the addition value n, to the number of times of application. However, in ACT33, it is assumed that the number of times of application is updated, with the upper limit being set to be the upper limit value of the number of times of application that can be set during the print period for printing one line (one dot) in the main scan direction. If the number of times of application corresponding to the addition value for the standard density exceeds the upper limit value of the settable number of times of application, the processor 45 may set the number of times of application at the upper limit value.

If the print speed is less than the speed threshold and the density setting is lower than the standard density (ACT32, NO), the processor 45 updates the number of times of application in accordance with the subtraction value for the standard density (ACT34). For example, if the subtraction value for the standard density is -n, the processor 45 updates the number of times of application to a value (standard density -n-b) obtained by subtracting -n from the number of times of application and further subtracting the predetermined number of times b from the number of times of application. However, in ACT34, it is assumed that the number of times of application is updated, such that the number of times of application that can be set during the print period for printing one line (one dot) in the main scan direction does not become less than one (lower limit value). In the case where the number of times of application corresponding to the subtraction value for the standard density becomes less than one, the processor 45 may set the number of times of application at one (lower limit value).

In FIG. 4, it is assumed that n-b is added to the number of times of application (or -n-b is subtracted from the number of times of application) in accordance with the addition value n (or subtraction value -n) for the standard value of the density setting in the case where the print speed is less than the speed threshold, but the embodiment is not limited to this. Specifically, the update number of times (the addition number of times or the subtraction number of times) of the number of times of application corresponding to the addition or subtraction value for the standard density may be set in accordance with print characteristics in the case where the print speed is less than the speed threshold, and the addition or subtraction value for the standard density of the density setting may not have a linear relation to the update number of times of the number of times of application.

As described above, the thermal printer according to the embodiment controls the number of times of application for heating each heating element of the thermal head during the print period during which the thermal head prints one line, in accordance with the printing condition acquired in the case of starting the print. Thereby, according to the thermal printer of the embodiment, the thermal control of the thermal head, which can obtain a print result with a clear density of an image, can be executed.

Additionally, the thermal printer functioning as the image forming apparatus according to the embodiment controls the number of times of application for heating each heating element during the print period for one line, in accordance with the print speed that is set according to the printing condition. Thereby, the thermal printer according to the embodiment can acquire a clear density of an image printed on a medium by the thermal head.

Additionally, the thermal printer functioning as the image forming apparatus according to the embodiment can switch the operation mode between the ink ribbon transfer mode and the photosensitive paper print mode. The thermal printer according to the embodiment can set the number of times of application corresponding to the operation mode even where the operation mode is the ink ribbon transfer mode or the photosensitive paper print mode, and can achieve a print result with a clear density of print, with the print density corresponding to the density setting regardless of the operation mode.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
a convey unit configured to convey a medium;
a thermal head including a plurality of heating elements arranged in a print line perpendicular to a convey direction of the medium by the convey unit;
a head driving unit configured to heat the heating elements corresponding to dots for one line in accordance with image data for each of the print lines; and
a processor configured to set a convey speed of the medium, and to set, in accordance with the convey speed, a number of times of application by which the head driving unit heats each of the heating elements of the thermal head.

2. The image forming apparatus of claim 1, wherein the number of times of application is a number of times of heating the heating elements of the thermal head during a print period for printing one dot.

3. The image forming apparatus of claim 2, wherein the processor is configured to set the number of times of application in accordance with the convey speed and a density setting of an image that is printed on the medium.

4. The image forming apparatus of claim 3, wherein the processor is configured to set the number of times of application to be greater in a case where the convey speed is equal to or more than a speed threshold, than in a case where the convey speed is less than the speed threshold.

5. The image forming apparatus of claim 3, wherein the processor is configured to change a standard number of times of the number of times of application in accordance with the convey speed and the density setting.

6. The image forming apparatus of claim 3, wherein the processor is configured to add a number of times, which is specified in accordance with the convey speed, to the number of times of application in a case where the density setting is higher than a standard, and to subtract the number of times, which is specified in accordance with the convey speed, from the number of times of application in a case where the density setting is lower than the standard.

7. The image forming apparatus of claim 3, wherein the processor is further configured to set the number of times of application in accordance with an operation mode of printing an image on the medium.

8. The image forming apparatus of claim 7, wherein the processor is configured to set, as the operation mode, a ribbon transfer mode of transferring an ink ribbon onto the medium, or a thermosensitive paper print mode of performing printing on thermosensitive paper serving as the medium, and to set the number of times of application to be greater in a case where the operation mode is the ribbon transfer mode than in a case where the operation mode is the thermosensitive paper print mode.

9. The image forming apparatus of claim 7, wherein the processor is configured to add a number of times, which is specified in accordance with each of the operation modes, to the number of times of application in a case where the density setting is higher than a standard, and to subtract the number of times, which is specified in accordance with each of the operation modes, from a standard number of times of the number of times of application in a case where the density setting is lower than the standard.

10. The image forming apparatus of claim 7, wherein the processor is configured to change a standard number of times of the number of times of application in accordance with the operation mode and the density setting, and is further configured to change the number of times of application in accordance with the convey speed and the density setting.

11. A non-transitory storage medium storing a program in an image forming apparatus comprising a thermal head including a plurality of heating elements arranged in a print line perpendicular to a convey direction of a medium; a head driving unit configured to heat the heating elements in the thermal head; and a processor, the program causing the processor to execute:
setting a convey speed of the medium; and
setting, in accordance with the convey speed, a number of times of application by which the head driving unit heats the heating element corresponding to one dot, thereby to print the dot in an image to be printed on the medium.

12. The non-transitory storage medium of claim 11, wherein the program causes the processor to execute:
setting the number of times of application that is a number of times of heating the heating elements of the thermal head during a print period for printing one dot.

13. The non-transitory storage medium of claim 12, wherein the program causes the processor to execute:
setting the number of times of application in accordance with the convey speed and a density setting of an image that is printed on the medium.

14. The non-transitory storage medium of claim 13, wherein the program causes the processor to execute:
setting the number of times of application to be greater in a case where the convey speed is equal to or more than a speed threshold, than in a case where the convey speed is less than the speed threshold.

15. The non-transitory storage medium of claim 13, wherein the program causes the processor to execute:
changing a standard number of times of the number of times of application in accordance with the convey speed and the density setting.

16. The non-transitory storage medium of claim 13, wherein the program causes the processor to execute:
adding a number of times, which is specified in accordance with the convey speed, to the number of times of application in a case where the density setting is higher than a standard; and
subtracting the number of times, which is specified in accordance with the convey speed, from the number of times of application in a case where the density setting is lower than the standard.

17. The non-transitory storage medium of claim 13, wherein the program causes the processor to execute:
further setting the number of times of application in accordance with an operation mode of printing an image on the medium.

18. The non-transitory storage medium of claim 17, wherein the program causes the processor to execute:
setting, as the operation mode, a ribbon transfer mode of transferring an ink ribbon onto the medium, or a thermosensitive paper print mode of performing printing on thermosensitive paper serving as the medium, and setting the number of times of application to be greater in a case where the operation mode is the ribbon transfer mode than in a case where the operation mode is the thermosensitive paper print mode.

19. The non-transitory storage medium of claim 17, wherein the program causes the processor to execute:
adding a number of times, which is specified in accordance with each of the operation modes, to the number of times of application in a case where the density setting is higher than a standard; and
subtracting the number of times, which is specified in accordance with each of the operation modes, from a standard number of times of the number of times of application in a case where the density setting is lower than the standard.

20. The non-transitory storage medium of claim 17, wherein the program causes the processor to execute:
changing a standard number of times of the number of times of application in accordance with the operation mode and the density setting; and
further changing the number of times of application in accordance with the convey speed and the density setting.
